(19) United States
(12) Patent Application Publication
(10) Pub. No.: US 2026/0229557 A1
(43) Pub. Date: Aug. 6, 2026

(54) MEMBRANE ELECTRODE ASSEMBLY PRODUCTION

(71) Applicant: GM GLOBAL TECHNOLOGY OPERATIONS LLC, Detroit, MI (US)

(72) Inventors: Swaminatha P. Kumaraguru, Rochester Hills, MI (US); Ruichun Jiang, Troy, MI (US); Craig S. Gittleman, West Bloomfield, MI (US); Jessica E. Compton, Waterford, MI (US)

(73) Assignee: GM GLOBAL TECHNOLOGY OPERATIONS LLC, Detroit, MI (US)

(21) Appl. No.: 19/044,539

(22) Filed: Feb. 3, 2025

(51) Int. Cl. H01M 8/0297; B60L 50/75; C25B 9/23; C25B 11/032; C25B 11/056; C25B 11/065; C25B 13/02; H01M 4/86; H01M 8/10; H01M 8/1004; H01M 50/46

(52) U.S. Cl. CPC H01M 8/0297; B60L 50/75; C25B 9/23; C25B 11/032; C25B 11/056; C25B 11/065; C25B 13/02; H01M 4/861; H01M 4/8657; H01M 8/1004; H01M 50/461; H01M 2008/1095; H01M 2220/20

(57) ABSTRACT

Electrochemical conversion cells including membrane electrode assemblies, devices including such electrochemical conversion cells, and methods for making membrane electrode assembles are provided. A method includes continuously coating a first electrode material directly onto a roll of an initial first substrate to form a first electrode coating thereon; continuously coating a second electrode material directly onto a roll of a second substrate to form a second electrode coating thereon; continuously coating a membrane material onto at least one of the first electrode coating and the second electrode coating to form a membrane coating thereon; joining the first electrode coating, membrane coating, and second electrode coating in a stack with the membrane coating located between the first electrode coating and the second electrode coating; and bonding a final first substrate to the first electrode coating.

### INTRODUCTION

The technical field relates generally to proton-exchange membranes (PEM) used in electrochemical conversion cells, and more particularly to methods for making membrane electrode assemblies.

Electrochemical conversion cells are devices that transform energy between chemical and electrical forms using electrochemical reactions. These cells include two primary types: fuel cells, which convert chemical energy into electrical energy, and electrolyzers, which do the opposite by using electrical energy to produce chemical energy. Both types share common components like electrodes, an electrolyte, and often catalysts, functioning through redox reactions where electrons are either consumed or generated at the electrodes, with ions moving through the electrolyte to complete the circuit.

Fuel cells are electrochemical devices that generate electricity directly from the chemical energy of a fuel, typically hydrogen, combined with oxygen from the air. The process involves splitting hydrogen at the anode into protons and electrons, which travel through an external circuit to produce electrical power, while protons pass through an electrolyte to the cathode to react with oxygen and form water. This process is clean and efficient, emitting only water and heat as byproducts, making fuel cells particularly appealing for applications requiring sustainable energy solutions, like in transportation and stationary power generation.

Electrolyzers, on the other hand, use electricity to split water into hydrogen and oxygen gases. In these devices, water is oxidized at the anode to generate protons, oxygen, and electrons, with the protons passing through a membrane to the cathode where they combine with electrons to form hydrogen. This technology is key to producing hydrogen as a clean energy carrier, which can be stored and used later in fuel cells or for industrial applications, thereby enabling the storage of renewable energy in chemical form.

Membrane Electrode Assemblies (MEAs) are key components of both fuel cells and electrolyzers.

It would be desirable to improve the manufacture of such Membrane Electrode Assemblies (MEAs). Furthermore, other desirable features and characteristics of the present disclosure will become apparent from the subsequent detailed description and the appended claims, taken in conjunction with the accompanying drawings and the foregoing introduction.

### SUMMARY

In one embodiment, a method is provided for making a membrane electrode assembly. The method includes continuously coating a first electrode material directly onto a roll of an initial first substrate to form a first electrode coating thereon; continuously coating a second electrode material directly onto a roll of a second substrate to form a second electrode coating thereon; continuously coating a membrane material onto at least one of the first electrode coating and the second electrode coating to form a membrane coating thereon; joining the first electrode coating, membrane coating, and second electrode coating in a stack with the membrane coating located between the first electrode coating and the second electrode coating; and bonding a final first substrate to the first electrode coating.

In certain embodiments, the method further includes cutting the roll into sheets.

In certain embodiments, the method further includes removing the initial first substrate from the first electrode coating.

In certain embodiments of the method, the initial first substrate is a polymeric material selected from polyethylene terephthalate, poly tetrafluoroethylene, polyimide, and combinations thereof.

In certain embodiments of the method, the second substrate is a gas diffusion layer including a carbon-based microporous layer and carbon fiber based macroporous layer.

In certain embodiments of the method, joining includes locating a sub-gasket between the first electrode coating and the second electrode coating.

In certain embodiments of the method, continuously coating the membrane material onto at least one of the first electrode coating and the second electrode coating includes continuously coating the membrane material onto the first electrode coating; and joining includes locating a sub-gasket between the membrane coating and the second electrode coating.

In certain embodiments of the method, continuously coating the membrane material onto at least one of the first electrode coating and the second electrode coating includes: continuously coating the membrane material onto the second electrode coating; and joining includes locating a sub-gasket between the membrane coating and the first electrode coating.

In certain embodiments of the method, continuously coating the membrane material onto at least one of the first electrode coating and the second electrode coating includes: continuously coating the membrane material onto the first electrode coating to form a first membrane coating thereon and continuously coating the membrane material onto the second electrode coating to form a second membrane coating thereon; and joining includes locating a sub-gasket between the first membrane coating and the second membrane coating.

In certain embodiments of the method, the membrane electrode assembly includes an electrolysis cell, and wherein the final first substrate is a porous transport layer.

In certain embodiments of the method, the membrane electrode assembly includes a fuel cell, and wherein the final first substrate is a gas diffusion layer.

In another embodiment, a method for making an electrolyzer is provided and includes forming a membrane electrode assembly by: continuously coating a first electrode material directly onto a roll of an initial first substrate to form a first electrode coating thereon; continuously coating a second electrode material directly onto a roll of a second substrate to form a second electrode coating thereon; continuously coating a membrane material onto at least one of the first electrode coating and the second electrode coating to form a membrane coating thereon; joining the first electrode coating, membrane coating, and second electrode coating in a stack with the membrane coating located between the first electrode coating and the second electrode coating; bonding a final first substrate to the first electrode coating; and locating the membrane electrode assembly between a first bipolar plate and a second bipolar plate to define water flow channels on an anode side of the membrane electrode assembly, hydrogen flow channels on a cathode side of the membrane electrode assembly, and oxygen flow channels of the membrane electrode assembly.

In certain embodiments, the method further includes removing the initial first substrate from the first electrode coating.

In certain embodiments of the method, continuously coating the membrane material onto at least one of the first electrode coating and the second electrode coating includes continuously coating the membrane material onto the first electrode coating; and joining includes locating a sub-gasket between the membrane coating and the second electrode coating.

In certain embodiments of the method, continuously coating the membrane material onto at least one of the first electrode coating and the second electrode coating includes: continuously coating the membrane material onto the second electrode coating; and joining includes locating a sub-gasket between the membrane coating and the first electrode coating.

In certain embodiments of the method, continuously coating the membrane material onto at least one of the first electrode coating and the second electrode coating includes: continuously coating the membrane material onto the first electrode coating to form a first membrane coating thereon and continuously coating the membrane material onto the second electrode coating to form a second membrane coating thereon; and joining includes locating a sub-gasket between the first membrane coating and the second membrane coating.

In another embodiment, a device is provided and includes a battery configured to store electricity; and an electrochemical conversion cell electrically connected to the battery, wherein the electrochemical conversion cell includes a membrane electrode assembly formed by: continuously coating a first electrode material directly onto a roll of an initial first substrate to form a first electrode coating thereon; continuously coating a second electrode material directly onto a roll of a second substrate to form a second electrode coating thereon; continuously coating a membrane material onto at least one of the first electrode coating and the second electrode coating to form a membrane coating thereon; joining the first electrode coating, membrane coating, and second electrode coating in a stack with the membrane coating located between the first electrode coating and the second electrode coating; and bonding a final first substrate to the first electrode coating.

In certain embodiments, the device is a vehicle.

In certain embodiments of the device, the membrane electrode assembly is formed by removing the initial first substrate from the first electrode coating.

In certain embodiments of the device, the initial first substrate is a polymeric material selected from polyethylene terephthalate, poly tetrafluoroethylene, polyimide, and combinations thereof.

### DESCRIPTION OF THE DRAWINGS

The present disclosure will hereinafter be described in conjunction with the following drawing figures, wherein like numerals denote like elements, and wherein:

FIG. 1 is a schematic cross-sectional view of an electrochemical conversion cell including a Membrane Electrode Assembly (MEA) between two bipolar plates in accordance with certain embodiments herein;

FIG. 2 is a schematic cross-sectional view of a Unitized Electrode Assembly (UEA) in accordance with certain embodiments herein;

FIG. 3 is a schematic illustrating a method for making the UEA of FIG. 2, in accordance with certain embodiments herein;

FIG. 4 is a schematic cross-sectional view of a Unitized Electrode Assembly (UEA) in accordance with certain embodiments herein;

FIG. 5 is a schematic illustrating a method for making the UEA of FIG. 4, in accordance with certain embodiments herein;

FIG. 6 is a schematic cross-sectional view of a Unitized Electrode Assembly (UEA) in accordance with certain embodiments herein; and

FIG. 7 is a schematic illustrating a method for making the UEA of FIG. 6, in accordance with certain embodiments herein.

FIG. 8 is a schematic illustrating a device including an electrochemical conversion cell having a gasketed MEA, in accordance with certain embodiments herein.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Finally, for the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

Method for making Membrane Electrode Assemblies and for making electrochemical conversion cells are provided. Exemplary embodiments include roll-to-roll coating of a membrane or membrane layers onto electrodes.

In certain embodiments of the roll-to-roll multilayer coating approach, the first electrode is coated onto a first polymeric substrate or decal, followed by membrane coating on the first electrode layer. Separately, the membrane is coated on a second electrode coated on a gas diffusion layer. The two membrane-coated components are then hot pressed against one another at the membrane coatings to form a hybrid coated membrane on electrode assembly. A sub-gasket overlapping the periphery of the membrane is applied in between the two assembly components.

In other embodiments, the membrane is coated only on the first electrode or the second electrode before the two components are hot pressed together. A sub-gasket overlapping the periphery of the membrane is applied in between the two assembly components.

After hot pressing to form a stack, the first substrate may be peeled off of the stack, and replaced with a final substrate. For example, the final substrate may be a porous transport layer (PTL). Thus, a stack may be formed using roll-to-roll coating processes while forming a final product including a porous transport layer (PTL) that may be too stiff to be formed in a roll and un-rolled for processing.

Embodiments herein may reduce the number of lamination steps and greatly simplify the assembly process in comparison with the industry standard processes.

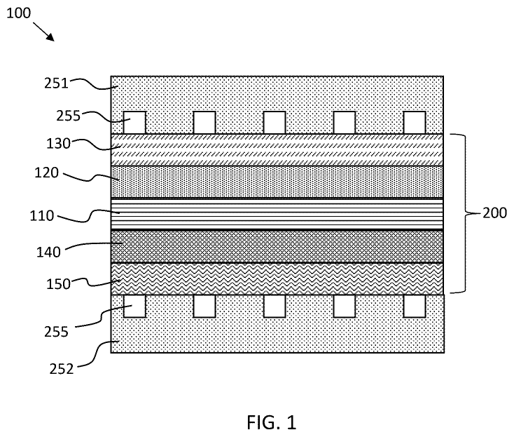

With reference to FIG. 1, a schematic cross section of an electrochemical conversion cell 100 is provided. In an exemplary embodiment, the electrochemical conversion cell is a proton exchange membrane electrochemical conversion cell 100 and includes a membrane 110. The membrane 110 may include multiple layers. For example, the membrane 110 may include a polymeric ion conducting layer, a polymeric ion conducting layer with radical scavengers, polymeric ion conducting layer with a polymeric reinforcement, polymeric ion conducting layers dispersed with recombination catalysts and polymeric ion conducting layer with recombination catalysts and radical scavengers etc.

The electrochemical conversion cell 100 further includes an anode electrode 120. The anode electrode 120 contacts the membrane 110.

Further, the electrochemical conversion cell 100 includes a substrate 130. As shown, the substrate 130 is in contact with the anode electrode 120. When the electrochemical conversion cell 100 is an electrolyzer, the substrate 130 may be a porous transport layer (PTL) 130. When the electrochemical conversion cell 100 is a fuel cell, the substrate 130 may be a gas diffusion layer (GDL) 130.

On the cathode side of the membrane 110, the electrochemical conversion cell 100 further includes a cathode electrode 140. The cathode electrode 140 contacts the membrane 110.

Further, the electrochemical conversion cell 100 includes a substrate 150. As shown, the substrate 150 is in contact with the cathode electrode 140. Substate 150 may be a gas diffusion layer (GDL) 150 when the electrochemical conversion cell 100 is an electrolyzer or a fuel cell.

Components 130, 120, 110, 140, and 150 may collectively form a Membrane Electrode Assembly (MEA) 200.

As shown, in the electrochemical conversion cell 100, the Membrane Electrode Assembly 200 is located between opposite flow field plates 251 and 252. In a refinement, flow field plates 250 are bipolar plates. Typically, flow field plates 251 and 252 are electrically conductive and are therefore formed from a metal such as stainless steel, titanium, or another suitable material. In other refinements, the flow field plates 251 and 252 are formed from carbon composite materials. In certain embodiments, the flow field plates 251 and 252 are coated with conductive coatings such as carbon coating, gold coating, platinum coating, or other suitable coating.

As shown, the flow field plates 250 form channels 255. Specifically, the channels 255 are open to the respective substrate 130 or 150. The channels 255 are provided for flowing hydrogen, oxygen, and water as determined by the use of the cell 100 as an electrolyzer or fuel cell.

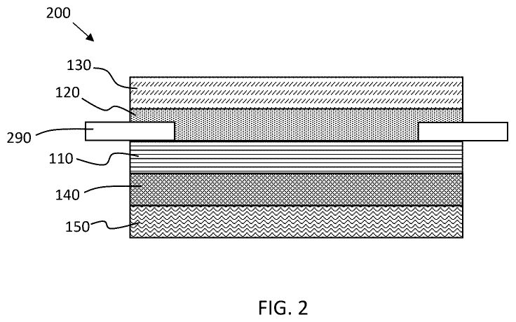

FIG. 2 illustrates an exemplary embodiment of a Unitized Electrode Assembly (UEA) including the MEA 200 of FIG. 1. It is noted that the terms “Unitized Electrode Assembly” and “UEA” refers to a “Membrane Electrode Assembly” or “MEA” further provided with gaskets, and may be used synonymously with the terms “gasketed Membrane Electrode Assembly” or “gasketed MEA”. In FIG. 2, the gasketed MEA 200 is provided with a sub-gasket 290. The sub-gasket 290 may provide a seal between the layers of the gasketed MEA 200 and the bipolar plates 250. The seal may prevent leakage of reactants, such as hydrogen and oxygen in a fuel cell, or products like water in electrolysis units. By sealing these components, the sub-gasket 290 ensures that the gases or liquids remain within the designated flow fields and do not escape or mix in unintended ways. The sub-gasket may help to evenly distribute the clamping pressure across the gasketed MEA 200. The sub-gasket 290 may isolate reactive surfaces from each other when they are not supposed to be in direct contact. The sub-gasket 290 may provide additional mechanical support to the delicate membrane of the gasketed MEA 200, helping to maintain its integrity under the operational conditions of the cell, which might involve temperature fluctuations, pressure changes, or mechanical stress from assembly.

In the embodiment of FIG. 2, the sub-gasket 290 is located between the membrane 110 and the anode electrode 120.

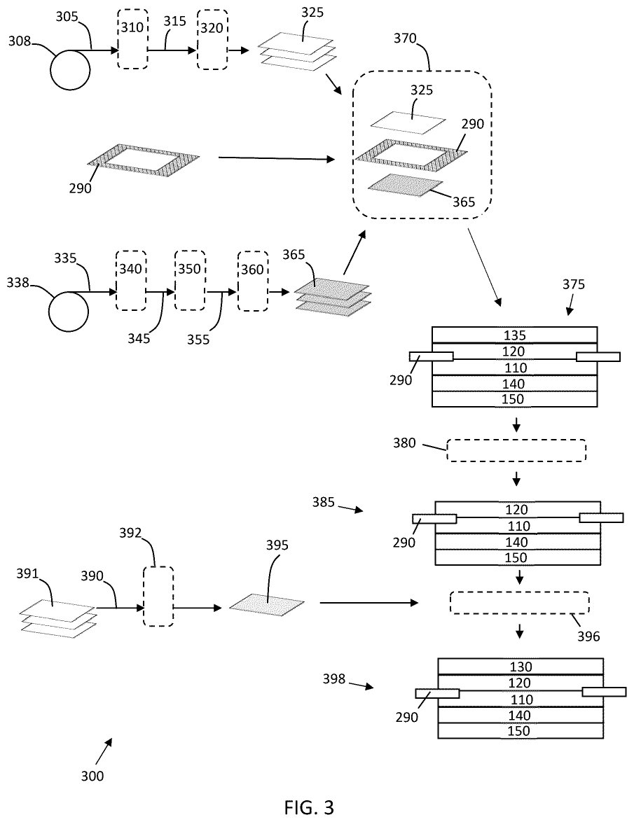

FIG. 3 illustrates a method 300 for forming the structure of the gasketed MEA 200 of FIG. 2.

As shown in FIG. 3, method 300 includes providing a first initial substrate 305 in the form of a web 305 wound in a roll 308.

As the web 305 is wound in a roll 308, the web 305 is typically formed from flexible material. When forming an MEA 200 for an electrolyzer or fuel cell, the web 305 may be a sacrificial or temporary material. In other words, the web 305 may be removed during later processing. In such embodiments, the web 305 may be a polymeric material selected from polyethylene terephthalate, poly tetrafluoroethylene, polyimide, and combinations thereof. In certain embodiments, the web 305 may be a gas diffusion layer (GDL), such as for forming an MEA 200 for a fuel cell.

Method 300 includes coating the web 305 at a coating/drying stage 310 with an anode ink to form an anode ink-coated web 315. Specifically, at the coating/drying stage 310, the anode ink may be applied continuously to the web 305. For example, the web 305 may be fed through the coating/drying stage 310 continuously and the anode ink-coated web 315 may be removed from the coating/drying stage 310 continuously.

After forming the anode ink coating on the web 315, the web 315 may be cut at cutting stage 320. As a result, individual anode ink-coated sheets 325 are formed.

Method 300 further includes providing a second substrate 335 in the form of a web 335 wound in a roll 338.

As the web 335 is wound in a roll 338, the web 335 is typically formed from flexible material. In certain embodiments, the web 335 may be a gas diffusion layer (GDL).

Method 300 further includes coating the web 335 with a cathode ink at coating stage 340 to form a cathode ink-coated web 345. In certain embodiments, method 300 includes coating the web 335 with a cathode ink and drying the ink coating and web at a coating/drying stage 340 to form a cathode ink-coated web 345. At stage 340, the cathode ink may be applied continuously to the web 335. For example, the web 335 may be fed through the coating/drying stage 340 continuously and the dried cathode ink-coated web 345 may be removed from the coating/drying stage 340 continuously.

As shown in FIG. 3, method 300 may further include coating the cathode ink-coated web 345 with membrane material at coating stage 350. In certain embodiments, method 300 includes coating the cathode ink-coated web 345 with membrane material and drying the membrane material and web at coating/drying stage 350. In certain embodiments, a single layer of membrane material may be coated onto the web 345. In other embodiments, multiple layers of membrane material may be coated onto the web 345.

As a result, a membrane-coated web 355 is formed. The membrane coating on membrane-coated web 355 may include a reinforcement layer comprising expanded PTFE and recombination catalysts, an ion conducting polymer, and a radical scavenger. The ion conducting polymer may be perfluoro sulfonic acid, such as Nafion™, or hydrocarbon ionomer, such as Pemion™. The recombination catalyst may be selected from platinum and palladium. The platinum and palladium catalyst may be unsupported nanoparticles or dispersed nanoparticles on carbon or oxidic particles. The radical scavenger may be selected from cerium and/or manganese containing compounds. For example, they may be introduced as cerium oxide or manganese oxide, etc. More generally, the radical scavenger may be a Ce/Mn containing nanoparticle.

After forming the membrane coating on the on the web 355, the web 355 may be cut at cutting stage 360. As a result, individual membrane-coated, cathode ink-coated sheets 365 are formed.

Method 300 includes, at pressing stage 370, joining an individual anode ink-coated sheet 325, a sub-gasket 290, and an individual membrane-coated, cathode ink-coated sheet 365 to form an intermediate stack 375. The pressing stage 370 may include hot pressing or laminating the components to form the stack 375.

As shown, the stack 375 includes the substrate 150 as a sheet from web 335, the cathode electrode 140 as the cathode ink coating on the web 335, the membrane 110 as the membrane coating on the cathode ink coating. Further, the stack includes an initial substrate 135 as a sheet from web 305, and the anode electrode 120 as the anode ink coating on the web 305. As indicated, the sub-gasket 290 is located between peripheral edges of the membrane 110 and the anode electrode 120.

Method 300 may continue at optional peeling stage 380 in embodiments in which the initial substrate 135 is sacrificial. In embodiments in which the initial substrate 135 is not sacrificial, no processing is performed at peeling stage 380.

At peeling stage 380, a sacrificial initial substrate 135 is removed from the stack 375, such as by peeling. While the initial substrate 135 is removed, the anode ink coating 120 remains in the stack 385 against the membrane 110.

As shown, method 300 further includes providing a first final or replacement substrate 390. In the illustrated embodiment, the replacement substrate may be a porous transport layer (PTL). For example, the porous transport layer may be comprised of sintered titanium.

Such a substrate 390 is not sufficiently flexible to be wound in a roll. Thus, the substrate 390 may be provided in the form of individual sheets 391.

As shown, method 300 may include, at coating/drying stage 392, coating the replacement substrate 390 with an adhesive, such as on the edges of the substrate, to form an adhesive coated substrate 395.

Method 300 includes, at pressing stage 396, joining the adhesive coated substrate 395 to the stack 385. Specifically, the adhesive coated substrate 395 is joined to the anode electrode 120. The pressing stage 396 may include hot pressing or laminating the components to form the stack 398, with the structure of the UEA of FIG. 2.

It is noted that while FIG. 3 illustrates that stiff replacement substrate 390 is provided in the form of sheets, in other embodiments the replacement substrate 390 may be flexible. For example, the replacement substate may be a gas diffusion layer when applied in fuel cell processing. In embodiments in which the replacement substrate 390 is flexible, the replacement substrate 390 may be provided in the form of a roll, as described above in reference to substrates 305 and 335, may be cut during an additional cutting stage, such as cutting stage 320 or 360, before or after the adhesive is applied at stage 392.

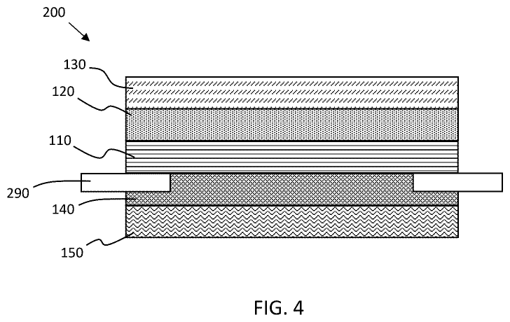

FIG. 4 illustrates another embodiment of a structure of a UEA or gasketed MEA 200. The gasketed MEA in FIG. 4 is similar to the gasketed MEA in FIG. 2, except that the sub-gasket is located between the membrane 110 and the cathode electrode 140.

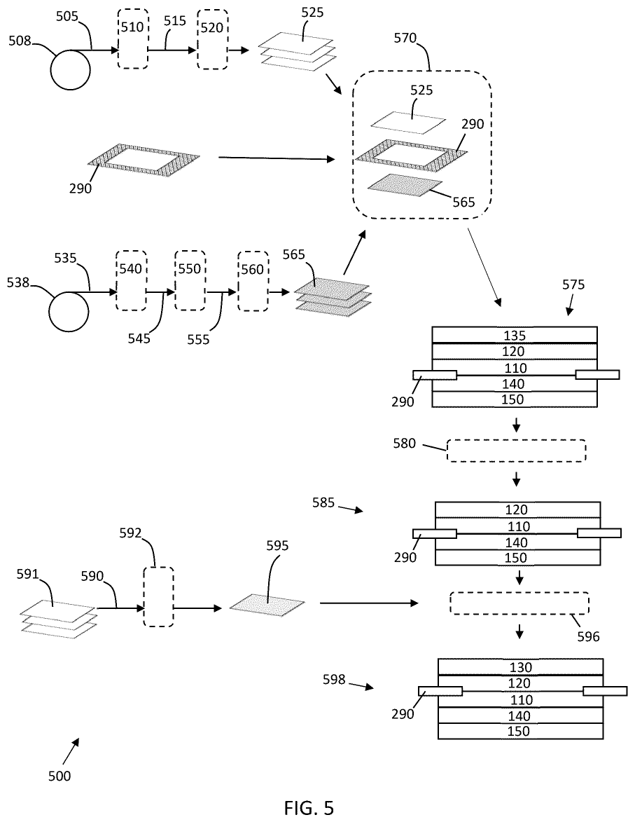

FIG. 5 illustrates a method 500 for forming the structure of the gasketed MEA 200 of FIG. 4.

As shown in FIG. 5, method 500 includes providing a second substrate 505 in the form of a web 505 wound in a roll 508. As the web 505 is wound in a roll 508, the web 505 is typically formed from flexible material. In certain embodiments, the web 505 may be a gas diffusion layer (GDL).

Method 500 includes coating the web 505 at a coating/drying stage 510 with a cathode ink to form a cathode ink-coated web 515. Specifically, at the coating/drying stage 510, the cathode ink may be applied continuously to the web 505. For example, the web 505 may be fed through the coating/drying stage 510 continuously and the cathode ink-coated web 515 may be removed from the coating/drying stage 510 continuously.

After forming the cathode ink coating on the web 515, the web 515 may be cut at cutting stage 520. As a result, individual cathode ink-coated sheets 525 are formed.

Method 500 further includes providing an initial first substrate 535 in the form of a web 535 wound in a roll 538.

As the web 535 is wound in a roll 538, the web 535 is typically formed from flexible material. When forming an MEA 200 for an electrolyzer or fuel cell, the web 535 may be a sacrificial or temporary material. In other words, the web 535 may be removed during later processing. In such embodiments, the web 535 may be a polymeric material selected from polyethylene terephthalate, poly tetrafluoroethylene, polyimide, and combinations thereof. In certain embodiments, the web 535 may be a non-sacrificial gas diffusion layer (GDL), such as for forming an MEA 200 for a fuel cell.

Method 500 further includes coating the web 535 at a coating/drying stage 540 with an anode ink to form an anode ink-coated web 545. Specifically, at the coating/drying stage 540, the anode ink may be applied continuously to the web 535. For example, the web 535 may be fed through the coating/drying stage 540 continuously and the anode ink-coated web 545 may be removed from the coating/drying stage 540 continuously.

As shown in FIG. 5, method 500 may further include coating the anode-ink-coated web 545 at coating/drying stage 550 with membrane material. In certain embodiments, a single layer of membrane material may be coated onto the web 545. In other embodiments, multiple layers of membrane material may be coated onto the web 545.

As a result, a membrane-coated web 555 is formed. The membrane coating on membrane-coated web 555 may include a reinforcement layer comprising expanded PTFE and recombination catalysts, an ion conducting polymer, a recombination catalyst, and a radical scavenger. The ion conducting polymer may be perfluoro sulfonic acid such as Nafion™ or hydrocarbon ionomer such as Pemion™. The recombination catalyst may be selected from platinum and palladium. The platinum and palladium catalyst may be unsupported nanoparticles or dispersed nanoparticles on carbon or oxidic particles. The radical scavenger may be selected from cerium and manganese containing compounds.

After forming the membrane coating on the on the web 555, the web 555 may be cut at cutting stage 560. As a result, individual membrane-coated, anode ink-coated sheets 565 are formed.

Method 500 includes, at pressing stage 570, joining an individual cathode ink-coated sheet 525, a sub-gasket 290, and an individual membrane-coated, anode ink-coated sheet 565 to form an intermediate stack 575. The pressing stage 570 may include hot pressing or laminating the components to form the stack 575.

As shown, the stack 575 includes the substrate 150 as a sheet from web 505, and the cathode electrode 140 as the cathode ink coating on the web 505. Further, the stack 575 includes an initial substrate 135 as a sheet from web 535, the anode electrode 120 as the anode ink coating on the web 505, and the membrane 110 as the membrane coating on the cathode ink coating. As indicated, the sub-gasket 290 is located between peripheral edges of the membrane 110 and the cathode electrode 140.

Method 500 may continue at optional peeling stage 580 in embodiments in which the initial substrate 135 is sacrificial. In embodiments in which the initial substrate 135 is not sacrificial, no processing is performed at peeling stage 580.

At peeling stage 580, a sacrificial initial substrate 135 is removed from the stack 575, such as by peeling. While the initial substrate 135 is removed, the anode ink coating 120 remains in the stack 585 against the membrane 110.

As shown, method 500 further includes providing a first final or replacement substrate 590. In the illustrated embodiment, the replacement substrate may be a porous transport layer (PTL). For example, the porous transport layer may be comprised of sintered titanium.

Such a substrate 590 is not sufficiently flexible to be wound in a roll. Thus, the substrate 590 may be provided in the form of individual sheets 591.

As shown, method 500 may include, at coating/drying stage 592, coating the replacement substrate 590 with an adhesive on the edges to form an adhesive coated substrate 595.

Method 500 includes, at pressing stage 596, joining the adhesive coated substrate 595 to the stack 585. Specifically, the adhesive coated substrate 595 is joined to the anode electrode 120. The pressing stage 596 may include hot pressing or laminating the components to form the stack 598, with the structure of the MEA of FIG. 4.

It is noted that while FIG. 5 illustrates stiff replacement substrate 590 provided in the form of sheets, in other embodiments the replacement substrate 590 may be flexible. For example, the replacement substate may be a gas diffusion layer. In embodiments in which the replacement substrate 590 is flexible, the replacement substrate 590 may be provided in the form of a roll, as described above in reference to substrates 505 and 535, may be cut during an additional cutting stage, such as cutting stage 520 or 560, before or after the adhesive is applied at stage 592.

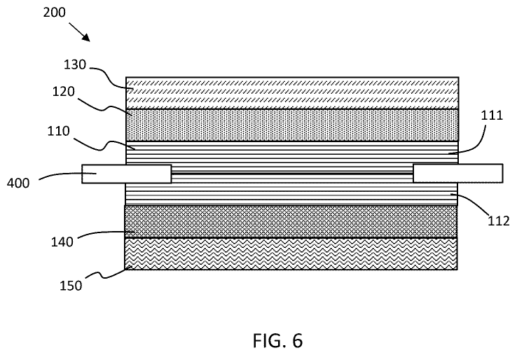

FIG. 6 illustrates another embodiment of a structure of a gasketed MEA 200. The gasketed MEA in FIG. 6 is similar to the gasketed MEA in FIGS. 2 and 4, except that the membrane 110 includes two separately formed layers 111 and 112, and the sub-gasket is located between the layers 111 and 112 of the membrane 110.

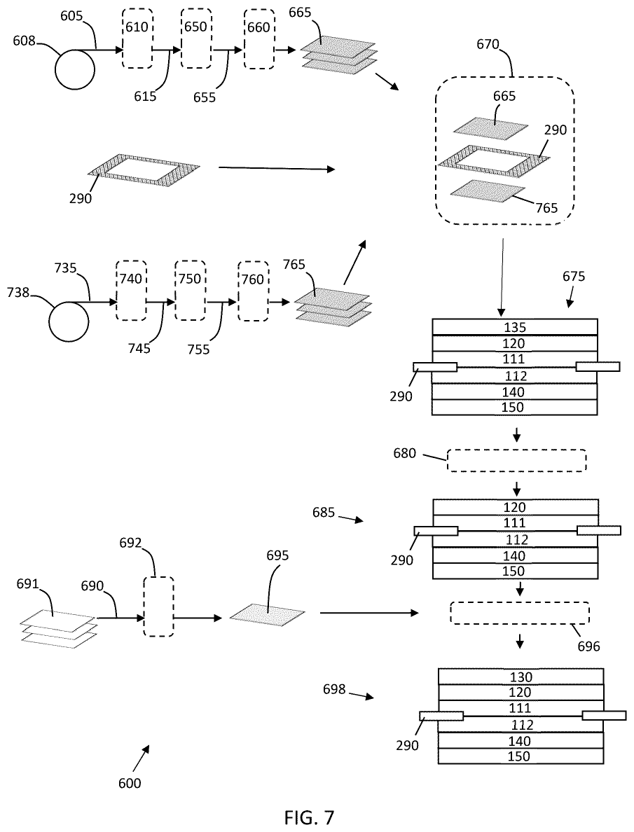

FIG. 7 illustrates a method 600 for forming the structure of the gasketed MEA 200 of FIG. 6.

As shown in FIG. 7, method 600 includes providing a first initial substrate 605 in the form of a web 605 wound in a roll 608.

As the web 605 is wound in a roll 608, the web 605 is typically formed from flexible material. When forming an MEA 200 for an electrolyzer and fuel cell, the web 605 may be a sacrificial or temporary material. In other words, the web 605 may be removed during later processing. In such embodiments, the web 605 may be a polymeric material selected from polyethylene terephthalate, poly tetrafluoroethylene, polyimide, and combinations thereof. In certain embodiments, the web 605 may be a non-sacrificial gas diffusion layer (GDL), such as for forming an MEA 200 for a fuel cell.

Method 600 includes coating the web 605 at a coating/drying stage 610 with an anode ink to form an anode ink-coated web 615. Specifically, at the coating/drying stage 610, the anode ink may be applied continuously to the web 605. For example, the web 605 may be fed through the coating/drying stage 610 continuously and the anode ink-coated web 615 may be removed from the coating/drying stage 610 continuously.

As shown in FIG. 7, method 600 may further include coating the anode-ink-coated web 615 at coating/drying stage 650 with membrane material. In certain embodiments, a single layer of membrane material may be coated onto the web 615. In other embodiments, multiple layers of membrane material may be coated onto the web 615.

As a result, a membrane-coated web 655 is formed. The membrane coating on membrane-coated web 655 may include a reinforcement layer comprising expanded PTFE and recombination catalysts, an ion conducting polymer, and a radical scavenger. The ion conducting polymer may be perfluoro sulfonic acid such as Nafion™ or hydrocarbon ionomer such as Pemion™. The recombination catalyst may be selected from platinum and palladium. The platinum and palladium catalyst may be unsupported nanoparticles or dispersed nanoparticles on carbon or oxidic particles. The radical scavenger may be selected from cerium and manganese containing compounds.

After forming the membrane coating on the on the web 655, the web 655 may be cut at cutting stage 660. As a result, individual membrane-coated, anode ink-coated sheets 665 are formed.

Method 600 further includes providing a second substrate 735 in the form of a web 735 wound in a roll 738.

As the web 735 is wound in a roll 738, the web 735 is typically formed from flexible material. In certain embodiments, the web 735 may be a gas diffusion layer (GDL).

Method 600 further includes coating the web 735 at a coating/drying stage 740 with a cathode ink to form a cathode ink-coated web 745. Specifically, at the coating/drying stage 740, the cathode ink may be applied continuously to the web 735. For example, the web 735 may be fed through the coating/drying stage 740 continuously and the cathode ink-coated web 745 may be removed from the coating/drying stage 740 continuously.

As shown in FIG. 7, method 600 may further include coating the cathode ink-coated web 745 at coating/drying stage 750 with membrane material. In certain embodiments, a single layer of membrane material may be coated onto the web 745. In other embodiments, multiple layers of membrane material may be coated onto the web 745.

As a result, a membrane-coated web 755 is formed. The membrane coating on membrane-coated web 755 may include a reinforcement layer comprising expanded PTFE, an ion conducting polymer, a recombination catalyst, and a radical scavenger. The ion conducting polymer may be perfluoro sulfonic acid. The recombination catalyst may be selected from platinum and palladium. The platinum and palladium catalyst may be unsupported nanoparticles or dispersed nanoparticles on carbon or oxidic particles. The radical scavenger may be selected from cerium and manganese containing compounds.

After forming the membrane coating on the web 755, the web 755 may be cut at cutting stage 760. As a result, individual membrane-coated, cathode ink-coated sheets 765 are formed.

Method 600 includes, at pressing stage 670, joining an individual membrane-coated, anode ink-coated sheet 665, a sub-gasket 290, and an individual membrane-coated, cathode ink-coated sheet 765 to form an intermediate stack 675. The pressing stage 670 may include hot pressing or laminating the components to form the stack 675.

As shown, the stack 675 includes the substrate 150 as a sheet from web 735, the cathode electrode 140 as the cathode ink coating on the web 735, and membrane layer 112 as the membrane coating on the cathode ink coating. Further, the stack includes an initial substrate 135 as a sheet from web 605, the anode electrode 120 as the anode ink coating on the web 605, and membrane layer 111 as the membrane coating on the anode ink coating. As indicated, the sub-gasket 290 is located between peripheral edges of membrane layer 111 and membrane layer 112.

Method 600 may continue at optional peeling stage 680 in embodiments in which the initial substrate 135 is sacrificial. In embodiments in which the initial substrate 135 is not sacrificial, no processing is performed at peeling stage 680.

At peeling stage 680, a sacrificial initial substrate 135 is removed from the stack 675, such as by peeling. While the initial substrate 135 is removed, the anode ink coating 120 remains in the stack 685 against the membrane 110.

As shown, method 600 further includes providing a first final or replacement substrate 690. In the illustrated embodiment, the replacement substrate may be a porous transport layer (PTL). For example, the porous transport layer may be comprised of sintered titanium.

Such a substrate 690 is not sufficiently flexible to be wound in a roll. Thus, the substrate 690 may be provided in the form of individual sheets 691.

As shown, method 600 may include, at coating/drying stage 692, coating the replacement substrate 690 with an adhesive to form an adhesive coated substrate 695.

Method 600 includes, at pressing stage 696, joining the adhesive coated substrate 695 to the stack 685. Specifically, the adhesive coated substrate 695 is joined to the anode electrode 120. The pressing stage 696 may include hot pressing or laminating the components to form the stack 698, with the structure of the gasketed MEA 200 of FIG. 6.

It is noted that while FIG. 7 illustrates stiff replacement substrate 690 provided in the form of sheets, in other embodiments the replacement substrate 690 may be flexible. For example, the replacement substate may be a gas diffusion layer. In embodiments in which the replacement substrate 690 is flexible, the replacement substrate 690 may be provided in the form of a roll, as described above in reference to substrates 605 and 735, may be cut during an additional cutting stage, such as cutting stage 660 or 760, before or after the adhesive is applied at stage 692.

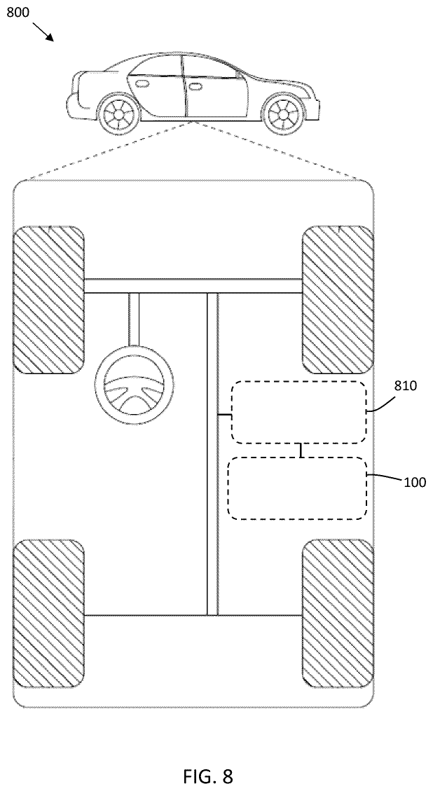

FIG. 8 is a schematic illustrating a device 800 including an electrochemical conversion cell 100, such as the electrochemical conversion cell 100 of FIG. 1. FIG. 8 illustrates the device 800 as a vehicle, such as an electric vehicle like an automobile, including any one of a number of different types of automobiles, such as, for example, a sedan, a wagon, a truck, sport utility vehicle (SUV), or the like. In certain implementations, the device 800 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the device 800 may instead be part of and/or coupled to any number of other types of platforms and/or other systems, moving or non-moving, such as a building, infrastructure, secondary use, home power, non-automotive, and/or other platforms and/or other systems.

The illustrated device 800 includes a battery module 810 for storing electricity. As shown, the battery module 810 is operatively connected to the electrochemical conversion cell 100. The battery module 810 may be charged by the electrochemical conversion cell 100, when the cell 100 is a fuel cell, or may provide electricity to the electrochemical conversion cell 100, when the cell is an electrolyzer.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for making a membrane electrode assembly, the method comprising:
continuously coating a first electrode material directly onto a roll of an initial first substrate to form a first electrode coating thereon;
continuously coating a second electrode material directly onto a roll of a second substrate to form a second electrode coating thereon;
continuously coating a membrane material onto at least one of the first electrode coating and the second electrode coating to form a membrane coating thereon;
joining the first electrode coating, membrane coating, and second electrode coating in a stack with the membrane coating located between the first electrode coating and the second electrode coating; and
bonding a final first substrate to the first electrode coating.

2. The method of claim 1, further comprising cutting the roll into sheets.

3. The method of claim 1, further comprising removing the initial first substrate from the first electrode coating.

4. The method of claim 3, wherein the initial first substrate is a polymeric material selected from polyethylene terephthalate, poly tetrafluoroethylene, polyimide, and combinations thereof.

5. The method of claim 1, wherein the second substrate is a gas diffusion layer comprising a carbon-based microporous layer and carbon fiber based macroporous layer.

6. The method of claim 1, wherein joining comprises locating a sub-gasket between the first electrode coating and the second electrode coating.

7. The method of claim 1, wherein:
continuously coating the membrane material onto at least one of the first electrode coating and the second electrode coating comprises continuously coating the membrane material onto the first electrode coating; and
joining comprises locating a sub-gasket between the membrane coating and the second electrode coating.

8. The method of claim 1, wherein continuously coating the membrane material onto at least one of the first electrode coating and the second electrode coating comprises:
continuously coating the membrane material onto the second electrode coating; and
joining comprises locating a sub-gasket between the membrane coating and the first electrode coating.

9. The method of claim 1, wherein continuously coating the membrane material onto at least one of the first electrode coating and the second electrode coating comprises:
continuously coating the membrane material onto the first electrode coating to form a first membrane coating thereon and continuously coating the membrane material onto the second electrode coating to form a second membrane coating thereon; and
joining comprises locating a sub-gasket between the first membrane coating and the second membrane coating.

10. The method of claim 1, wherein the membrane electrode assembly comprises an electrolysis cell, and wherein the final first substrate is a porous transport layer.

11. The method of claim 1, wherein the membrane electrode assembly comprises a fuel cell, and wherein the final first substrate is a gas diffusion layer.

12. A method for making an electrolyzer, the method comprising:
forming a membrane electrode assembly by:
continuously coating a first electrode material directly onto a roll of an initial first substrate to form a first electrode coating thereon;
continuously coating a second electrode material directly onto a roll of a second substrate to form a second electrode coating thereon;
continuously coating a membrane material onto at least one of the first electrode coating and the second electrode coating to form a membrane coating thereon;
joining the first electrode coating, membrane coating, and second electrode coating in a stack with the membrane coating located between the first electrode coating and the second electrode coating;
bonding a final first substrate to the first electrode coating; and
locating the membrane electrode assembly between a first bipolar plate and a second bipolar plate to define water flow channels on an anode side of the membrane electrode assembly, hydrogen flow channels on a cathode side of the membrane electrode assembly, and oxygen flow channels of the membrane electrode assembly.

13. The method of claim 12, further comprising:
removing the initial first substrate from the first electrode coating.

14. The method of claim 12, wherein:
continuously coating the membrane material onto at least one of the first electrode coating and the second electrode coating comprises continuously coating the membrane material onto the first electrode coating; and
joining comprises locating a sub-gasket between the membrane coating and the second electrode coating.

15. The method of claim 12, wherein continuously coating the membrane material onto at least one of the first electrode coating and the second electrode coating comprises:
continuously coating the membrane material onto the second electrode coating; and
joining comprises locating a sub-gasket between the membrane coating and the first electrode coating.

16. The method of claim 12, wherein continuously coating the membrane material onto at least one of the first electrode coating and the second electrode coating comprises:
continuously coating the membrane material onto the first electrode coating to form a first membrane coating thereon and continuously coating the membrane material onto the second electrode coating to form a second membrane coating thereon; and
joining comprises locating a sub-gasket between the first membrane coating and the second membrane coating.

17. A device comprising:
a battery configured to store electricity; and
an electrochemical conversion cell electrically connected to the battery, wherein the electrochemical conversion cell comprises a membrane electrode assembly formed by:
continuously coating a first electrode material directly onto a roll of an initial first substrate to form a first electrode coating thereon;
continuously coating a second electrode material directly onto a roll of a second substrate to form a second electrode coating thereon;
continuously coating a membrane material onto at least one of the first electrode coating and the second electrode coating to form a membrane coating thereon;
joining the first electrode coating, membrane coating, and second electrode coating in a stack with the membrane coating located between the first electrode coating and the second electrode coating; and
bonding a final first substrate to the first electrode coating.

18. The device of claim 17, wherein the device is a vehicle.

19. The device of claim 17, wherein the membrane electrode assembly is formed by removing the initial first substrate from the first electrode coating.

20. The device of claim 19, wherein the initial first substrate is a polymeric material selected from polyethylene terephthalate, poly tetrafluoroethylene, polyimide, and combinations thereof.
